(19) United States
(12) Patent Application Publication
(10) Pub. No.: US 2016/0219076 A1
(43) Pub. Date: Jul. 28, 2016

(54) HARDWARE TRUST FOR INTEGRATED NETWORK FUNCTION VIRTUALIZATION (NFV) AND SOFTWARE DEFINED NETWORK (SDN) SYSTEMS

(71) Applicant: Sprint Communications Company L.P., Overland Park, KS (US)

(72) Inventors: Lyle Walter Paczkowski, Mission Hills, KS (US); Arun Rajagopal, Leawood, KS (US); Ronald R. Marquardt, Woodinville, WA (US)

(21) Appl. No.: 14/605,569

(22) Filed: Jan. 26, 2015

(51) Int. Cl. H04L 29/06; G06F 9/455

(52) U.S. Cl. CPC H04L 63/20; G06F 9/45558; H04L 63/08; G06F 2009/45595

(57) ABSTRACT

A data communication system has data processing circuitry to transfer data communications. Trust modules establish and maintain network trust of the data processing circuitry. A Network Function Virtualization (NFV) system executes hypervisors to establish and maintain an NFV processing environment in the data processing circuitry. A Software Defined Network (SDN) system executes SDN applications, SDN controllers, and SDN data machines in the data processing circuitry during NFV slices to transfer the data communications. The data communication system maintains a data structure that associates, based on execution relationships, individual blocks of the data processing circuitry, the trust modules, the hypervisors, the NFV slices, the SDN applications, the SDN controllers, and the SDN data machines. The database may be queried for the hardware trust data related to specific NFV and SDN software modules.

### TECHNICAL BACKGROUND

Data communication systems transfer data packets between user devices and machines to provide data communication services like internet access, media streaming, and user messaging. The data communication systems are implementing several technologies in a contemporaneous manner to improve service delivery. These technologies include systems for Network Function Virtualization (NFV), Software-Defined Networks (SDNs), and network hardware trust.

The NFV systems increase capacity and efficiency. NFV computer platforms run hypervisor software to execute various software modules during sets of processing time cycles—referred to as NFV slices. The software modules often comprise virtual machines, such as virtual packet gateways, virtual Internet Protocol (IP) routers, and the like. Different networks are mapped to different NFV threads to isolate the networks from one another.

The SDN systems improve service provisioning and management. SDNs have separate control and data planes. SDN controllers interact with SDN applications to control SDN data plane machines. The SDN applications process application-layer data to direct the SDN controllers, and in response, the SDN controllers direct the SDN data plane machines to process and transfer user data packets. The SDN applications may comprise gateways, servers, and the like. These SDN applications may be associated together to form virtual Long Term Evolution (LTE) access nodes, LTE core networks, and Internet Multimedia Subsystem (IMS) servers.

The hardware trust systems ensure network security and control. The trust systems maintain physical separation between trusted hardware and untrusted hardware. The trust systems control software access to the trusted hardware but allow interaction between open and secure software components through secure bus interfaces, memories, and switching circuits. The trust systems establish trust with one another by using secret keys embedded in their hardware to generate hash results for remote verification by other trust systems also knowing the secret key and the hash algorithm. Unfortunately, the trust systems have not been effectively integrated with the NFV systems and the SDN systems.

### TECHNICAL OVERVIEW

A data communication system has data processing circuitry to transfer data communications. Trust modules establish and maintain network trust of the data processing circuitry. A Network Function Virtualization (NFV) system executes hypervisors to establish and maintain an NFV processing environment in the data processing circuitry. A Software Defined Network (SDN) system executes SDN applications, SDN controllers, and SDN data machines in the data processing circuitry during NFV slices to transfer the data communications. The data communication system maintains a data structure that associates, based on execution relationships, individual blocks of the data processing circuitry, the trust modules, the hypervisors, the NFV slices, the SDN applications, the SDN controllers, and the SDN data machines. The database may be queried for the hardware trust data related to specific NFV and SDN software modules.

### DESCRIPTION OF THE DRAWINGS

FIGS. 1-2 illustrate a data communication system that integrates a network trust system with a Network Function Virtualization (NFV) system and a Software-Defined Network (SDN) system.

FIGS. 3-4 illustrate a data communication system to integrate network trust systems with NFV/SDN systems for a Long Term Evolution (LTE) core network.

FIGS. 5-6 illustrate a data communication system to integrate a network trust system with NFV/SDN systems for an LTE access node.

FIG. 7 illustrates a distributed database to associate data processing circuitry, trust modules, hypervisors, NFV slices, SDN controllers, SDN applications, SDN data machines, and hardware trust status.

FIG. 8 illustrates a virtualized network computer system to integrate trust, NFV, and SDN systems.

### DETAILED DESCRIPTION

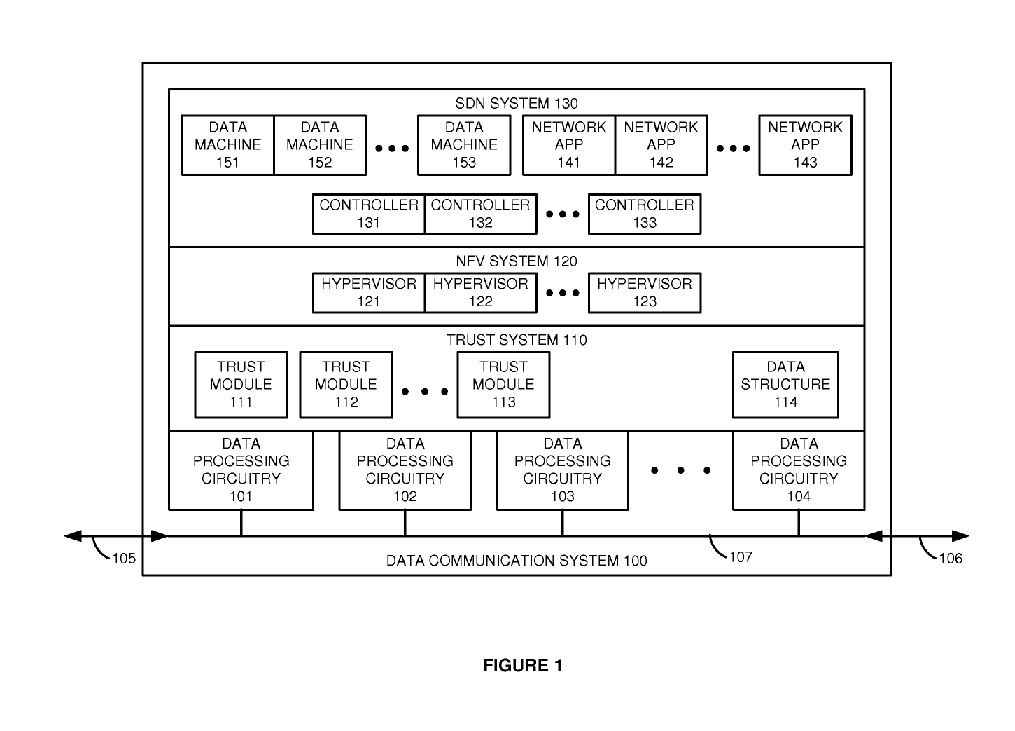

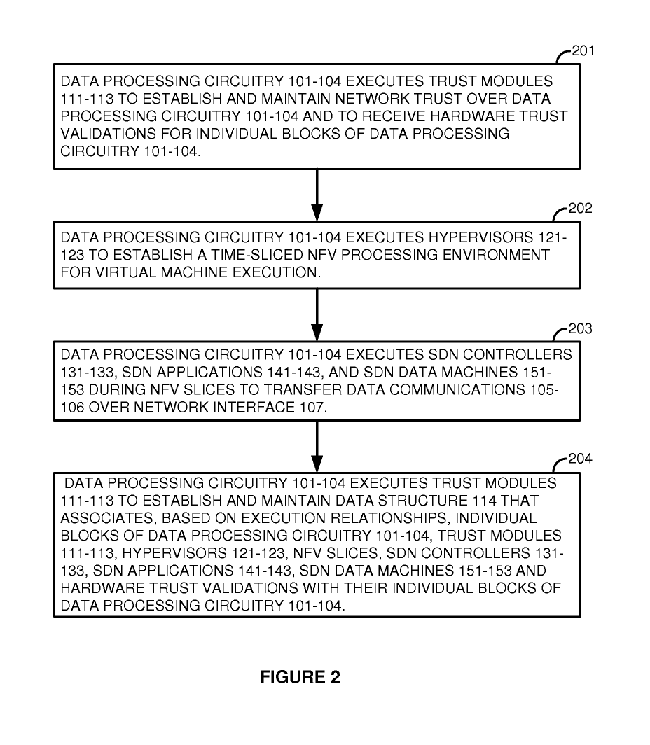

FIGS. 1-2 illustrate data communication system 100 to integrate network trust system 110 with Network Function Virtualization (NFV) system 120 and Software-Defined Network (SDN) system 130. Data communication system 100 comprises: data processing circuitry 101-104, network interface 107, trust system 110, NFV system 120, and SDN system 130. Trust system 110 includes trust modules 111-113 and data structure 114. NFV system 120 includes hypervisors 121-123. SDN system 130 includes SDN controllers 131-133, network applications 141-143, and data machines 151-153. Note that the amount of circuitry and software modules shown on FIG. 1 is exemplary. The amount of circuitry and software modules will vary in other examples.

Data processing circuitry 101-104 is depicted as four blocks of circuitry, where an individual block comprises a physically discrete set of microprocessors, bus interfaces, memory devices, and other standard electronic components. Exemplary blocks of data processing circuitry 101-104 include microprocessors, server blades, servers, and data center computers. Data processing circuitry 101-104 stores, retrieves, and executes various software modules including: trust modules 111-113, hypervisors 121-123, SDN controllers 131-133, SDN network applications 141-143, and data machines 151-153. As directed by these software modules, data communication system 100 exchanges data communications 105-106 for various users.

Data communications 105-106 support internet access, media conferencing, media streaming, messaging, gaming, machine control, and the like For example, data communication system 100 may exchange Internet Protocol (IP) packets between thousands of wireless base stations and the Internet. In another example, data communication system 100 might exchange user data blocks between a set of Radio Frequency (RF) transceivers and a pair of core data networks. Data communication system 100 may physically reside at one or more physical sites.

Network interface 107 comprises network interface cards, bus structures, cabling, controllers, switches, and the like to exchange data communications 105-106 among data processing circuitry 101-104 and external systems. Network interface 107 typically has SDN data plane capability to operate based on flow tables managed by SDN controllers 131-133.

In operation, data processing circuitry 101-104 executes trust modules 111-113 to establish and maintain network trust of the circuitry. For example, trust module 111 may direct data processing circuitry 101 to read a secret key that was previously embedded within data processing circuitry 101 and generate a trust value based on the secret key. In some cases, trust module 111 receives a random number challenge and responsively generates the trust value using the random number, the secret key, and a one-way hash algorithm. Data processing circuitry 101-104 executes trust modules 111-113 to receive hardware trust validations for the individual blocks of data processing circuitry 101-104 responsive to the transferred trust values. Further, data processing circuitry 101-104 executes trust modules 111-113 to transfer the hardware trust validations for data association within data structure 114.

Data processing circuitry 101-104 executes hypervisors 121-123 to establish a time-sliced NFV processing environment for virtual machine execution. Data processing circuitry 101-104 executes SDN controllers 131-133, SDN applications 141-143, and SDN data machines 151-153 during various NFV slices to transfer data communications 105-106 over network interface 107. SDN applications 141-143 use an SDN Application Programming Interfaces (APIs) to exchange application data with SDN controllers 131-133 over a northbound SDN interface. SDN controllers 131-133 process the application data to control flow tables in the SDN plane over the southbound SDN interface. The SDN data plane is represented on FIG. 1 by network interface 107 and data machines 151-153 when executed in circuitry 101-104.

Data processing circuitry 101-104 executes trust modules 111-113 to establish and maintain data structure 114 that associates, based on execution relationships, individual ones of data processing circuitry 101-104, trust modules 111-113, hypervisors 121-123, NFV slices, SDN controllers 131-133, SDN applications 141-143, and SDN data machines 151-153. Trust modules 111-113 may also associate, based on these execution relationships, the hardware trust validations with their individual data processing circuitry 101-104, trust modules 111-113, hypervisors 121-123, NFV slices, SDN controllers 131-133, SDN applications 141-143, and SDN data machines 151-153.

Data communication system 100 may receive trust queries for various individual software modules. In response, data communication system 100 processes data structure 114 to identify the current hardware trust validation for the specific data processing circuitry and NFV slice the executes the individual software modules. Data communication system 100 transfers a response to the query indicating the hardware trust validations for the individual software modules.

For example, trust module 113, hypervisor 123, SDN controller 133, SDN application 143, and SDN data machine 153 may execute on data processing circuitry 104 during NFV slice N. A remote system (or a module in system 100) may transfer a query for the current hardware trust status of trust module 113, hypervisor 123, SDN controller 133, SDN application 143, and SDN data machine 153. Data communication system 100 processes the query and data structure 114 to identify the hardware trust validation for data processing circuitry 104 during NFV slice N.

If data processing circuitry 104 was trusted during NFV slice N, then data communication system 100 responds with a trusted hardware indication for trust module 113, hypervisor 123, SDN controller 133, SDN application 143, and SDN data machine 153. If data processing circuitry 104 was not trusted during NFV slice N, then data communication system 100 responds with an untrusted hardware indication for trust module 113, hypervisor 123, SDN controller 133, SDN application 143, and SDN data machine 153. In a complex communication system with millions of SDN modules and NFV cycles, these execution-based relationships including hardware trust status are important to monitor and manage.

Referring to FIG. 2, the operation of data communication system 100 is described. Data processing circuitry 101-104 executes trust modules 111-113 to establish and maintain network trust over data processing circuitry 101-104 and to receive hardware trust validations for individual blocks of data processing circuitry 101-104 (201). For example, trust module 112 may obtain a secret key from data processing circuitry 102 for remote trust verification. Data processing circuitry 101-104 executes hypervisors 121-123 to establish a time-sliced NFV processing environment for virtual machine execution (202). Data processing circuitry 101-104 executes SDN controllers 131-133, SDN applications 141-143, and SDN data machines 151-153 during various NFV slices to transfer data communications 105-106 over network interface 107 (203). For example, the SDN modules may inspect, transcode, and route an IP packet flow from an ingress port to an egress port of network interface 107. Data processing circuitry 101-104 executes trust modules 111-113 to establish and maintain data structure 114 that associates, based on execution relationships, individual blocks of data processing circuitry 101-104, trust modules 111-113, hypervisors 121-123, NFV slices, SDN controllers 131-133, SDN applications 141-143, SDN data machines 151-153, and hardware trust validations (204). Data communication system 100 may receive and process queries against data structure 114 to transfer responses with hardware trust information.

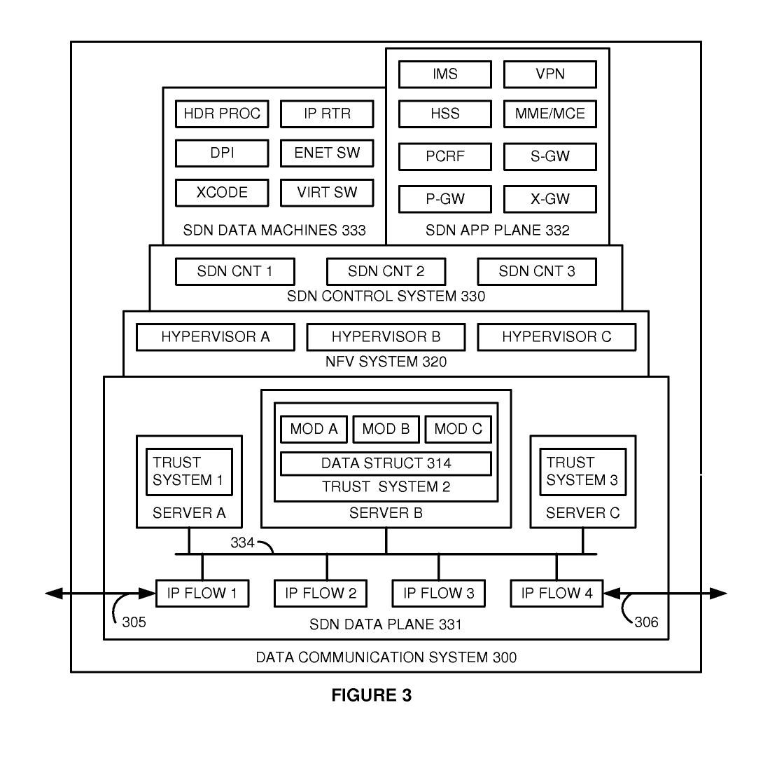

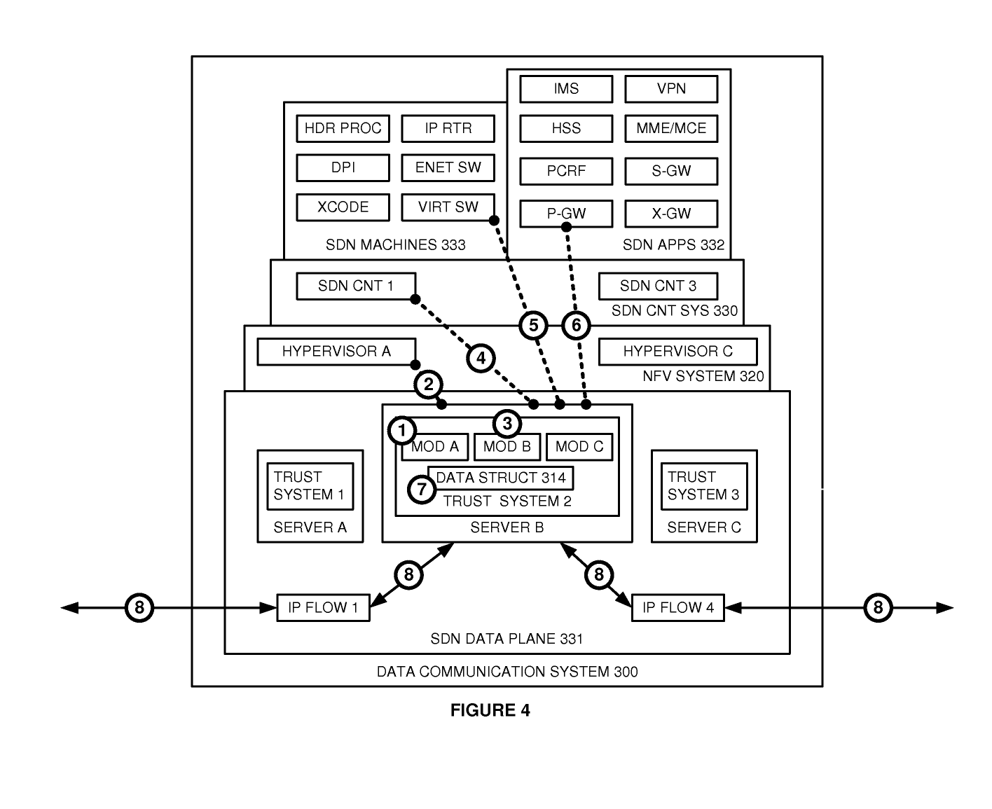

FIGS. 3-4 illustrate data communication system 300 to integrate network trust systems with NFV/SDN systems for a Long Term Evolution (LTE) core network. Data communication system 300 is an example of data communication system 100, although system 100 may use alternative configurations and operations. Data communication system 300 exchanges data communications 305-306 for various users to support data services like internet access, media transfers, machine control, file access, and the like. In data communication system 300, the number of components shown on FIG. 3 is illustrative, and various numbers of servers, software modules, and the like could be present in system 300.

Data communication system 300 comprises NFV system 320, SDN control system 330, SDN data plane 331, SDN application plane 332, and SDN data machines 333. SDN data plane 331 comprises IP flow processors 1-4, network interface 334, and servers A-C. IP flow processors 1-4 comprise physical IP routing machines that direct individual flows of IP packets from incoming ports to outgoing ports based on IP flow tables. IP flow processors 1-4 may also apply packet-level features such as header translation, media transcoding, payload inspection, caching, and the like based on the flow tables. The flow tables in IP flow processors 1-4 are loaded by SDN control system 330 using southbound SDN interfaces.

Network interface 334 comprises network interface cards, layer 2 switches, bus interfaces, communication circuitry, and the like. Servers A-C might be blades, Central Processing Units (CPUs), CPU cores, microprocessors, computerized circuit boards, or some other type of computer system. Servers A-C include trust systems 1-3. In server B, trust system 2 has trust modules A-C and data structure 314, and trust systems 1 and 3 would be similar. Network interface 334 and IP flow processors 1-5 may also have trust systems. Network interface 334 and IP flow processors 1-4 are configured to operate according to SDN standards.

Trust system 2 includes portions of the circuitry, memory, bus interface, and software in server B. Trust system 2 establishes and maintains physical control over software and data access to server B. Trust system 2 typically establishes control by loading one or more of trust modules A-C during server B initialization. Trust system 2 includes physical switching to couple and de-couple select components in server B, such as microprocessors, memory devices, user interfaces, communication ports, and the like. Trust system 2 may use the switching to read or scan for a secret key that is embedded within server B. Trust system 2 exchanges trust data with other trust systems using a hash of the secret key to validate itself, and trust system 2 may host trust data and validate other trust systems.

NFV system 320 includes multiple hypervisors A-C. Hypervisors A-C comprise software modules that are stored and executed by servers A-C. Hypervisors A-C direct servers A-C to operate in a virtualized manner to support the execution of virtual machines in a multi-threaded and time-sliced manner. Hypervisors A-C implement context switching to isolate networks of these virtual machines executing on servers A-C. Hypervisors A-C use virtual network interfaces executing in servers A-C to provide data communications over physical network interface 334. Hypervisors A-C are configured to operate according to NFV standards.

SDN control system 330 has multiple SDN controllers 1-3. SDN controllers comprises virtual machine software modules that are stored and executed by servers A-C. SDN controllers 1-3 exchange application data with SDN application plane 332 using SDN Application Programming Interfaces (APIs) over northbound SDN interfaces. SDN controllers 1-3 process the application data to exchange control data with IP flow processors 1-5 and data machines 333 over southbound SDN interfaces. SDN controllers 1-3 are configured to operate according to NFV and SDN standards.

When executed by servers A-C, SDN data machines 333 perform IP flow and packet operations based on flow tables. The flow tables in SDN data machines 333 are loaded by SDN control system 330 using southbound SDN interfaces. An exemplary list of virtual machines for SDN data machines 333 includes: IP header processor (HDR PROC), Deep Packet Inspection (DPI) unit, media transcoder (XCODE), virtual switch (VIRT SW), Ethernet Switch (ENET SW), and IP Router (IP RTR). SDN data machines 333 are configured to operate according to NFV and SDN standards.

SDN application plane 332 comprises various network applications to direct the IP flows and packet operations in IP flow processors 1-5 and data machines 333. SDN application plane 332 exerts this control through the application data exchange with SDN control system 320 over the northbound SDN interface. An exemplary list of virtual machines for SDN application plane 332 includes: Internet Multimedia Subsystem (IMS) servers, Virtual Private Network (VPN) servers, Home Subscriber System (HSS) servers, Mobility Management Entities (MMEs) and Multi-Cell Coordination Entities (MCEs), Policy Charging and Rules Function (PCRF) servers, Service Gateways (S-GWs), Packet Data Network Gateways (P-GWs), and X-Gateways (X-GWs)—where X-GW represents various gateways for Wireless Fidelity networks, 3G communication networks, digital voice networks, enterprise data systems, and the like. The virtual machines of SDN application plane 332 are configured to operate according to LTE, NFV, and SDN standards.

Referring to FIG. 4 and in a first operation, server B executes trust module A to establish control over server B and to support hypervisor A. In a second operation, hypervisor A executes on server B and interacts with trust module 1. In a third operation, trust module B executes on server B to support SDN controller 1. In a fourth operation, SDN controller 1 runs on server B in an NFV slice and interacts with trust module B.

In a fifth operation, a virtual switch executes on server B in the NFV slice to perform SDN data plane tasks. In a sixth operation, a P-GW application executes on server B in the NFV slice to provide application data to SDN controller 1. Typically, numerous additional applications 332 and machines 333 would run on server B in the NFV slice to form a virtual LTE core network. Various other networks could run during other NFV slices.

In a seventh operation, trust modules A-B receive virtual machine execution histories and status data from hypervisor A and SDN controller 1. Based on the execution histories, trust modules 1-2 associate server B, trust modules A-B, hypervisor A, used NFV slices, SDN controller 1, P-GW app 332, virtual switch machine 333, IP flow processors 1 and 4, and other associated virtual machines. Trust modules A-B load and update data structure 314 with these data associations.

Trust system 2 repeatedly verifies hardware trust for server B—possibly through the exchange of trust data with an external trust system to obtain remote trust verification. Trust modules A-B then associate the current trust status for server B with the executing software modules. Data structure 314 indicates the current server trust status for the software modules like hypervisor A, SDN controller 1, and the P-GW. Trust modules A-B may also associate the current trust status for network interfaces and IP flow processors with the software modules that they service. Data structure 314 can associate specific network by its name, SDN applications, SDN controllers, SDN data machines, NFV hypervisors, trust modules, servers, NFV slices, network interfaces, and IP flow processors. Data structure 314 can also indicate the hardware trust status for the SDN, servers, network interfaces, and IP flow processors. Thus, data structure 314 can indicate the current hardware trust status for the virtual machines that form a virtual LTE core network or some other virtual communication networks.

In an eighth operation, IP flow processor 1 receives user data packets and forwards the packets to server B responsive to SDN control signaling. Server B virtually switches the data packets and may perform other tasks, like IP header translation, before forwarding the data packets to IP flow processor 4. IP flow processor 4 receives the user data packets and forwards the data packets toward a destination responsive to SDN control signaling. User data packets may flow from IP flow processor 4 through server B and IP flow processor 1 in a similar manner. Note that a numeric operational sequence is described above for organizational clarity, but the various operations will typically overlap in some aspects.

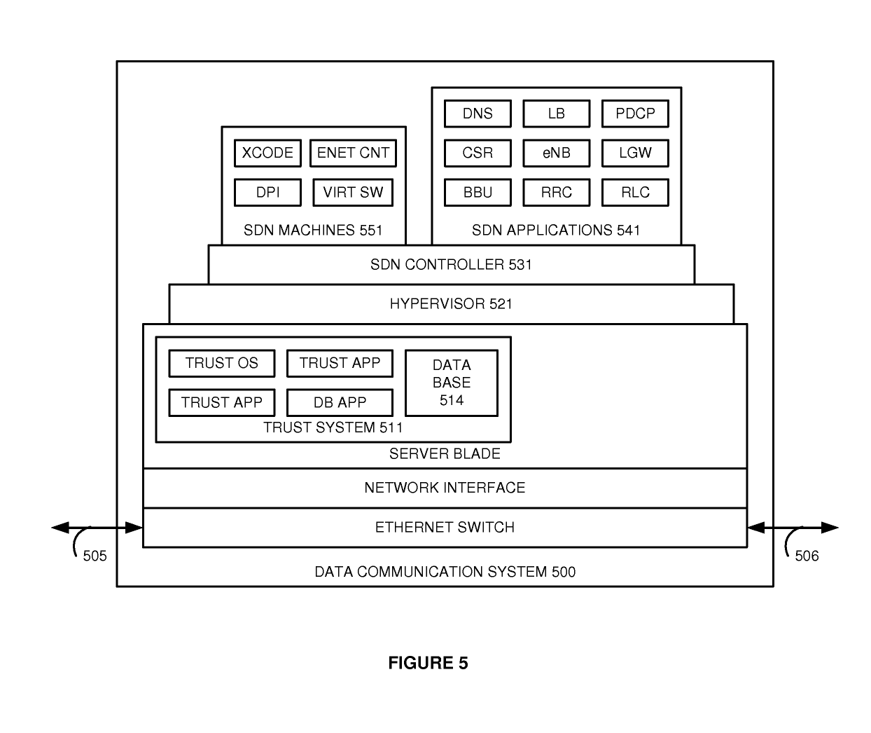

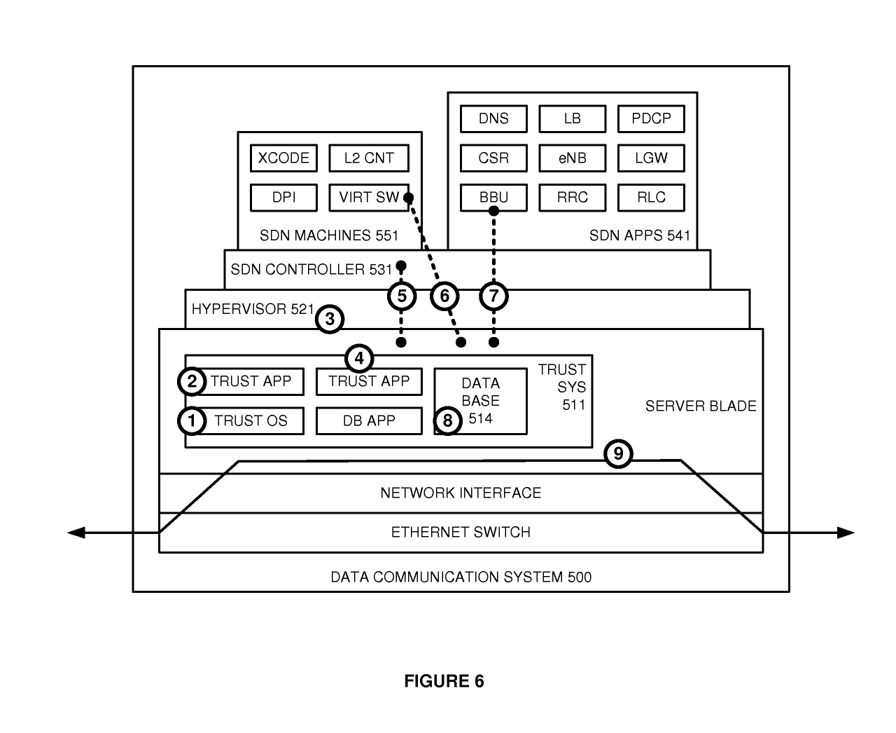

FIGS. 5-6 illustrate data communication system 500 to integrate network trust system 511 with NFV/SDN systems for an LTE access node. Data communication system 500 is an example of data communication system 100, although system 100 may use alternative configurations and operations. Data communication system 500 exchanges data communications 505-506 for various users to support data services like internet access, media transfers, machine control, file access, and the like. In data communication system 500, the number of components shown on FIG. 5 is illustrative, and various numbers of switches, blades, software modules, and the like could be present in system 500.

Data communication system 500 comprises an Ethernet switch, network interface, server blade, hypervisor 521, SDN controller 531, SDN applications 541, and SDN virtual machines 551. The Ethernet switch directs flows of user data from incoming ports to outgoing ports based on flow tables. The flow tables in the Ethernet switch are loaded by SDN controller 531 using a southbound SDN interface.

The network interface comprises a server backplane structure and associated control circuitry. The server blade comprises microprocessors, memory devices, and communication circuitry on a circuit board. The server blade includes trust system 511. Trust system 511 has an Operating System (OS), trust applications, database application, and database 514. The network interface and Ethernet switch may also have similar trust systems.

Trust system 511 includes circuitry, memory, bus interfaces, and software. Trust system 511 establishes and maintains physical control over software and data access to the server blade. Trust system 511 establishes control by loading the trust OS during server blade initialization. Trust system 511 includes physical switching to couple and de-couple select components in the server blade, such as the microprocessors, memory devices, and communication circuitry. Trust system 511 may use the switching to read a secret key that is embedded within the server blade. Trust system 511 exchanges trust data with other trust systems using a hash of the secret key to validate itself, and trust system 511 may host trust data and validate other trust systems.

Hypervisor 521 supports the execution of virtual machines in an NFV time-sliced manner. Hypervisor 521 provides virtual network interfaces for data communications over the network interface and the Ethernet switch. SDN controller 531 communicates with SDN applications 541 using APIs over the northbound interface. SDN controller 531 processes the application data to exchange control data with the Ethernet switch over the southbound interface.

When executed by the server blade, SDN data machines 551 perform data operations based on flow tables. The flow tables in SDN data machines 551 are loaded by SDN controller 531 using the southbound interface. An exemplary list of virtual SDN data machines 551 includes: Deep Packet Inspection (DPI) unit, media transcoder (XCODE), virtual switch (VIRT SW), and Ethernet Controller (ENET CNT).

SDN applications 541 comprise various network applications to direct the data flows and operations in the Ethernet switch and the server blade. SDN applications 541 exert this control through the application data exchange with SDN controller 531 over the northbound interface. An exemplary list of virtual machines for SDN applications 541 includes: Domain Name Service (DNS) server, Load Balancer (LB), Packet Data Control Protocol (PDCP) processor, Cell Site Router (CSR), evolved-Node B (eNB) station, Local P-GW (L-GW), Baseband Unit (BBU), Radio Resource Control (RRC) processor, and Radio Link Control (RLC) processor.

Referring to FIG. 6 and in a first operation, the server blade executes the trust OS to establish control over the server blade. In a second operation, a trust application runs on the blade to support hypervisor 521. In a third operation, hypervisor 521 executes on the server blade and interacts with its trust application. In a fourth operation, another trust application executes on the server blade to support SDN controller 531. In a fifth operation, SDN controller 531 runs on the server blade during an NFV slice and interacts with its trust application.

In a sixth operation, a virtual switch executes on the server blade in the NFV slice to perform SDN data plane tasks. In a seventh operation, a BBU executes on the server blade in the NFV slice to provide application data to SDN controller 531. Typically, numerous additional applications 541 and machines 551 would run on the server blade in the NFV slice to form a virtual LTE access node. Various other access nodes could run during other NFV slices.

In an eighth operation, the trust applications receive virtual machine execution histories and status data from hypervisor 521 and SDN controller 531. The trust applications send the execution histories and the status data to the database application. Based on the execution histories, the database application associates the server blade, trust OS, trust applications, hypervisor 521, NFV slice, SDN controller 531, BBU app 541, virtual switch 551, the network interface, and the Ethernet switch. The database application loads data structure 514 with these data associations.

The trust OS repeatedly verifies hardware trust for the server blade—possibly through the exchange of trust data with an external trust system to obtain remote trust verification. The trust OS sends the hardware trust status for the server blade to the database application. The database application associates the current trust status for the server blade with the executing software modules. Data structure 514 indicates the current server trust status for the software modules like hypervisor 521, SDN controller 531, and the BBU. The database application may also associate the current trust status for the network interface and the Ethernet switch with the software modules that they service. Data structure 514 can identify a specific access node by its SDN applications, SDN controller, SDN data machines, NFV hypervisor, trust modules, server blade, NFV slice, network interface, and Ethernet switch. Data structure 514 can indicate the hardware trust status for the server blade, NFV slice, network interface, and Ethernet switch. Thus, data structure 514 can indicate the hardware trust status associated with the virtual machines that form LTE access nodes and other virtual communication nodes.

In a ninth operation, the Ethernet switch receives user data and forwards the data to the virtual switch in the server blade responsive to SDN control signaling. The server blade virtually switches the data and may perform other tasks, like media transcoding, before forwarding the data back to the Ethernet switch. The Ethernet switch then forwards the data toward a destination responsive to SDN control signaling. Note that a numeric operational sequence is described above for organizational clarity, but the various operations will typically overlap in some aspects.

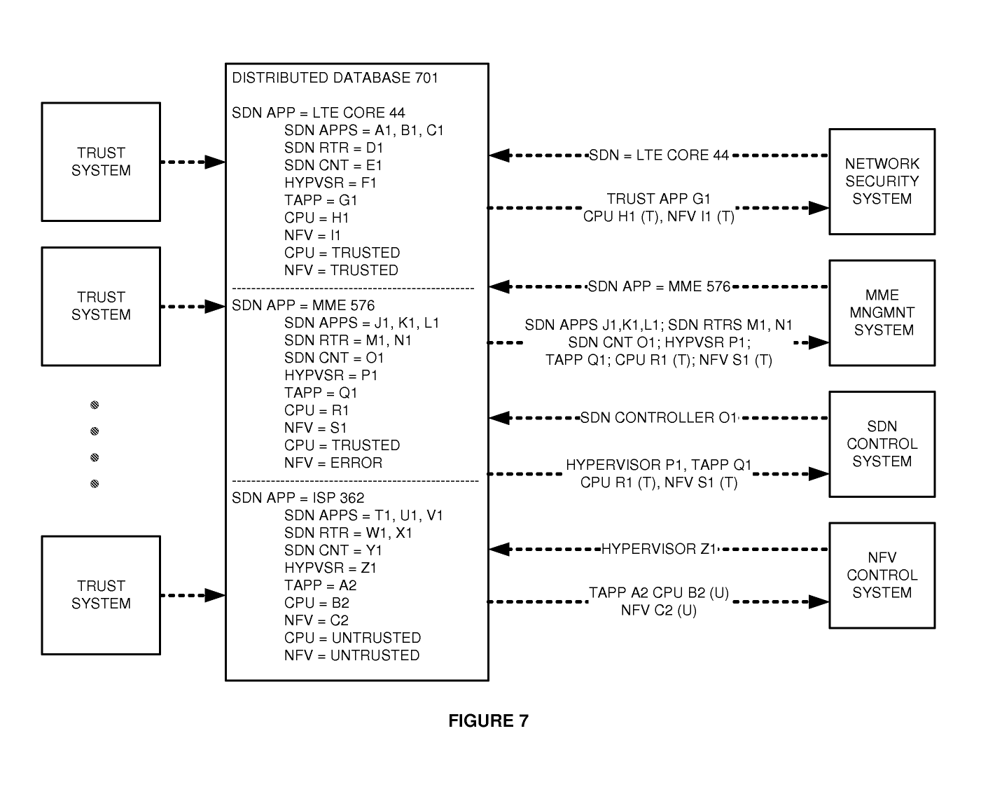

FIG. 7 illustrates distributed database 701 to associate data processing circuitry, trust modules, hypervisors, NFV slices, SDN controllers, SDN applications, SDN data machines, and hardware trust status. Distributed database 701 is an example of data structures 114, 314, and 514, although these data structures may use other configurations and operations. Database 701 is loaded by various trust systems. Database 701 serves a robust set of data to various entities on-demand.

A network security system queries distributed database 701 for information related to an SDN named LTE CORE 44. Database 701 responds with information like the CPU H1, Trust Application G1, and NFV slice I1. The data also indicates that both CPU H1 is currently in a state of Hardware Trust (T) during and NFV thread I1. Various additional information could be provided for the SDN LTE CORE 44, such as hypervisor F1 and SDN controller E1.

An MME management system queries distributed database 701 for information related to an SDN application called MME 576. Database 701 responds with information like associated SDN apps J1, K1, L1, SDN routers M1, N1, SDN controller O1, hypervisor P1, trust application Q1, CPU R1, and NFV thread S1. The data also indicates that CPU R1 and NFV slice S1 are currently in a state of Hardware Trust (T).

An SDN control system queries distributed database 701 for information related to SDN controller O1. Database 701 responds with information like associated hypervisor P1, Trust Application Q1, CPU R1, and NFV thread S1. The data also indicates that CPU R1 at NFV slice S1 is currently in a state of Hardware Trust (T).

An NFV control system queries distributed database 701 for information related to hypervisor Z1. Database 701 responds with information like associated Trust Application A2, CPU B2, and NFV thread C2. The data also indicates that CPU B2 during NFV thread C2 is not currently in a state of Hardware Trust (U).

Distributed database 701 could provide various data and reports upon demand or subscription. Distributed database 701 could host various alarm triggers and transfer corresponding alarm alerts as required. For example, a database application could transfer alarms to various endpoints based on the loss of trust for a CPU and/or NFV slice. In addition, the database application could transfer alarms to various endpoints based on the loss of trust for a CPU and/or NFV slice that is executing a specified NFV hypervisor and/or a particular SDN machine, application, or controller.

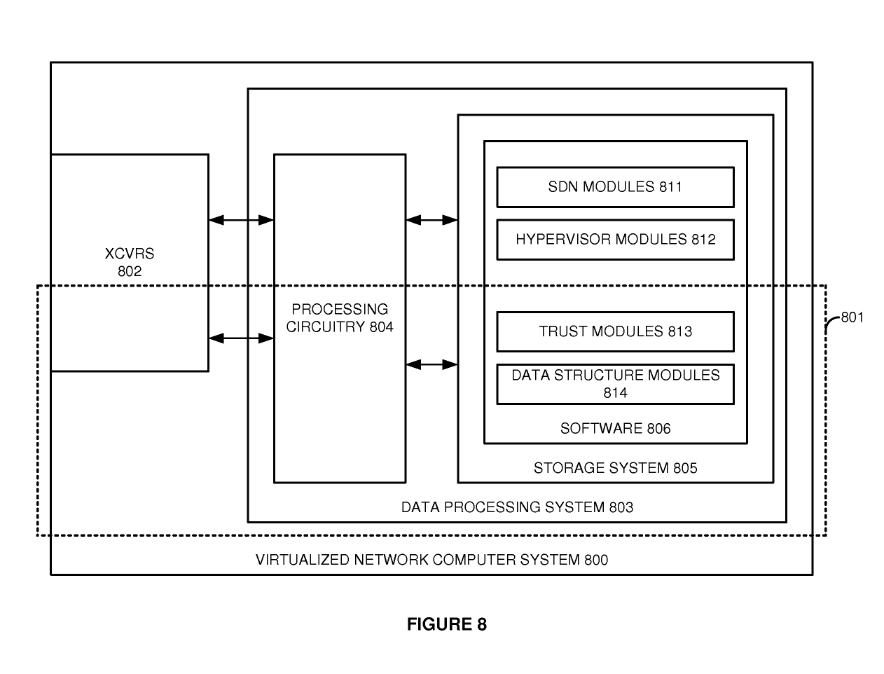

FIG. 8 illustrates virtualized network computer system 800 to integrate trust, NFV, and SDN systems. Virtualized network computer system 800 is an example of systems 100, 300, 500, and 701, although these computer systems may use alternative configurations and operations. Virtualized network computer system 800 comprises communication transceivers 802 and data processing system 803. Communication transceivers 802 comprise components, such as ports, bus interfaces, signal processors, memory, software, and the like. Communication transceivers 802 exchange user data, network signaling, software modules, and the like. Data processing system 803 comprises processing circuitry 804 and storage system 805. Storage system 805 stores software 806. Software 806 includes software modules 811-814. Some conventional aspects of computer system 800 are omitted for clarity, such as power supplies, enclosures, and the like. Virtualized network computer system 800 may be centralized or distributed.

In data processing system 803, processing circuitry 804 comprises server blades, circuit boards, bus interfaces and connections, integrated circuitry, and associated electronics. Storage system 805 comprises non-transitory, machine-readable, data storage media, such as flash drives, disc drives, memory circuitry, tape drives, servers, and the like. Software 806 comprises machine-readable instructions that control the operation of processing circuitry 804 when executed. Software 806 includes software modules 811-814 and may also include operating systems, applications, data structures, virtual machines, utilities, databases, and the like. All or portions of software 806 may be externally stored on one or more storage media, such as circuitry, discs, tape, and the like.

When executed by processing circuitry 804, trust modules 813 direct circuitry 804 to maintain a physically secure and trusted partition 801 of transceivers 802, processing circuitry 803, memory 804, and software 806. Trust modules 813 also direct circuitry 804 to execute hypervisor modules 812 outside of trusted partition 801. When executed by processing circuitry 804, hypervisor modules 812 direct circuitry 804 to operate an NFV data processing environment for SDN modules 811. When executed by processing circuitry 804, SDN modules 811 direct circuitry 804 to receive, process, and transfer data packets based on SDN applications.

SDN modules 811 and hypervisor modules 812 have corresponding trust applications in trust modules 813. The trust applications in trust modules 813 supply hardware trust verifications and associated trusted transactions for modules 811-812. SDN modules 811 and hypervisor modules 812 transfer status information including software execution history data to their trust applications in trust modules 813. Trust modules 813 load and update data structure modules 814 with trust and status information for the various NFV and SDN network elements.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a data communication system comprising data processing circuitry to transfer data communications, the method comprising:
executing trust modules in the data processing circuitry to establish and maintain network trust of the data processing circuitry;
executing hypervisors in the data processing circuitry to establish and maintain a Network Function Virtualization (NFV) processing environment;
executing Software Defined Network (SDN) applications, SDN controllers, and SDN data machines in the data processing circuitry during NFV slices to transfer the data communications; and
maintaining a data structure that associates, based on execution relationships, individual blocks of the data processing circuitry, the trust modules, the hypervisors, the NFV slices, the SDN applications, the SDN controllers, and the SDN data machines.

2. The method of claim 1 wherein establishing and maintaining the network trust of the data processing circuitry comprises:
reading secret keys embedded in the individual blocks of the data processing circuitry;
generating trust values based on the secret keys and transferring the trust values; and
receiving hardware trust validations for the individual blocks of the data processing circuitry responsive to the transferred trust values.

3. The method of claim 2 further comprising maintaining the data structure to associate, based on the execution relationships, the hardware trust validations for the individual blocks of the data processing circuitry with the NFV slices, the trust modules, the hypervisors, the SDN applications, the SDN controllers, and the SDN data machines.

4. The method of claim 3 further comprising:
receiving a trust query for one of the SDN controllers;
processing the data structure to identify one of the hardware trust validations for the block of the data processing circuitry executing the one of the SDN controllers;
transferring a response indicating the one of the hardware trust validations for the one of the SDN controllers.

5. The method of claim 3 further comprising:
receiving a trust query for one of the hypervisors;
processing the data structure to identify one of the hardware trust validations for the block of the data processing circuitry executing the one of the hypervisors;
transferring a response indicating the one of the hardware trust validations for the one of the hypervisors.

6. The method of claim 3 further comprising:
receiving a trust query for one of the SDN applications;
processing the data structure to identify one of the hardware trust validations for the block of the data processing circuitry executing the one of the SDN applications;
transferring a response indicating the one of the hardware trust validations for the one of the SDN applications.

7. The method of claim 3 further comprising:
receiving a trust query for one of the SDN data machines;
processing the data structure to identify one of the hardware trust validations for the block of the data processing circuitry executing the one of the SDN data machines;
transferring a response indicating the one of the hardware trust validations for the one of the SDN data machines.

8. The method of claim 1 wherein the network applications comprise Long Term Evolution (LTE) core network applications.

9. The method of claim 1 wherein the network applications comprise Long Term Evolution (LTE) access node applications.

10. The method of claim 1 wherein the network applications comprises Internet Multimedia Subsystem (IMS) server applications.

11. A data communication system comprising data processing circuitry to transfer data communications, the method comprising:
a trust system configured to establish and maintain network trust of the data processing circuitry;
a Network Function Virtualization (NFV) system configured to execute hypervisors in the data processing circuitry to establish and maintain an NFV processing environment;
a Software Defined Network (SDN) system to execute SDN applications, SDN controllers, and SDN data machines in the data processing circuitry during NFV slices to transfer the data communications; and
a data structure that associates, based on execution relationships, individual blocks of the data processing circuitry, the trust modules, the hypervisors, the NFV slices, the SDN applications, the SDN controllers, and the SDN data machines.

12. The data communication system of claim 11 wherein the trust system is configured to read secret keys embedded in the individual blocks of the data processing circuitry, generate trust values based on the secret keys, transfer the trust values, and receive hardware trust validations for the individual blocks of the data processing circuitry responsive to the transferred trust values.

13. The data communication system of claim 12 wherein the data structure is configured to associate, based on the execution relationships, the hardware trust validations for the individual blocks of the data processing circuitry with the NFV slices, the trust modules, the hypervisors, the SDN applications, the SDN controllers, and the SDN data machines.

14. The data communication system of claim 13 wherein the trust system is configured to receive a trust query for one of the SDN controllers, process the data structure to identify one of the hardware trust validations for the block of the data processing circuitry executing the one of the SDN controllers, and transfer a response indicating the one of the hardware trust validations for the one of the SDN controllers.

15. The data communication system of claim 13 wherein the trust system is configured to receive a trust query for one of the hypervisors, process the data structure to identify one of the hardware trust validations for the block of the data processing circuitry executing the one of the hypervisors, and transfer a response indicating the one of the hardware trust validations for the one of the hypervisors.

16. The data communication system of claim 13 wherein the trust system is configured to receive a trust query for one of the SDN applications, process the data structure to identify one of the hardware trust validations for the block of the data processing circuitry executing the one of the SDN applications, and transfer a response indicating the one of the hardware trust validations for the one of the SDN applications.

17. The data communication system of claim 13 wherein the trust system is configured to receive a trust query for one of the SDN data machines, process the data structure to identify one of the hardware trust validations for the block of the data processing circuitry executing the one of the SDN data machines, and transfer a response indicating the one of the hardware trust validations for the one of the SDN data machines.

18. The data communication system of claim 11 wherein the network applications comprise Long Term Evolution (LTE) core network applications.

19. The data communication system of claim 11 wherein the network applications comprise Long Term Evolution (LTE) access node applications.

20. The data communication system of claim 11 wherein the network applications comprise Internet Multimedia Subsystem (IMS) server applications.
